(19) United States
(12) Patent Application Publication
(10) Pub. No.: US 2025/0383841 A1
(43) Pub. Date: Dec. 18, 2025

(54) DEVICE AND METHOD FOR BIT-STREAM GENERATION FOR STOCHASTIC COMPUTING APPLICATIONS

(71) Applicant: University of Louisiana at Lafayette, Lafayette, LA (US)

(72) Inventors: Mohammadhassan Najafi, Lafayette, LA (US); Mehran Shoushtari Moghadam, Lafayette, LA (US); Sercan Aygun, Lafayette, LA (US); Sina Asadi, Lafayette, LA (US)

(73) Assignee: University of Louisiana at Lafayette, Lafayette, LA (US)

(21) Appl. No.: 19/238,245

(22) Filed: Jun. 13, 2025

Related U.S. Application Data
(60) Provisional application No. 63/659,553, filed on Jun. 13, 2024.

(51) Int. Cl. G06F 7/535

(52) U.S. Cl. CPC G06F 7/535

(57) ABSTRACT

A cost-effective and highly efficient bit-stream generator for stochastic computing division circuits implementing powers-of-2 Van der Corput (VDC) sequences for bit-stream generation, providing high accuracy operation and low-cost implementation. The correlator design provides high-quality input bit-streams for all stochastic computing division designs, wherein a single random number generator is shared among the input bit-streams of the stochastic computing divider circuit.

### CROSS-REFERENCE TO RELATED APPLICATIONS

This application claims priority to U.S. Provisional Application No. 63/659,553 titled “Efficient Bit-Stream Generator for Accurate Stochastic Computing Division” filed on Jun. 13, 2024.

### STATEMENT REGARDING FEDERALLY SPONSORED RESEARCH OR DEVELOPMENT

This work was funded in party by Grant Nos. 2019511 and 2339701 from the National Science Foundation.

### REFERENCE TO A “SEQUENCE LISTING,” A TABLE, OR A COMPUTER PROGRAM

Not applicable.

### FIELD OF THE INVENTION

The field of the invention is stochastic computing, namely implementing division operations in stochastic computing applications.

### BRIEF DESCRIPTION OF THE DRAWINGS

The drawings constitute a part of this specification and include exemplary embodiments of the invention disclosed herein, which may be embodied in various forms. It is to be understood that in some instances, various aspects of the invention may be shown exaggerated or enlarged to facilitate an understanding of the invention. Therefore, the drawings may not be to scale.

FIG. 1A is a logic diagram of a bit-stream generator that shares a common random number generator (correlated case).

FIG. 1B is a logic diagram of a bit-stream generator with unshared random number generators (uncorrelated case).

FIG. 2 provides an overview of applying different random number generators on the design of stochastic computing divider circuits.

FIG. 3 is a table showing the chronological development of SC dividers, where FF stands for Flip-Flop.

FIG. 4 provides the flow of the disclosed method and device incorporating a bit-stream generator (including random sequence sources-Sobol, VDC, LFSR) and a correlator to generate the correlated second bit-stream. It is noted that X<Y for the SC division operation (X/Y).

FIG. 5 provides Algorithm 1 flow for efficient correlated bit-stream generation.

FIG. 6 provides Algorithm 2 flow for CORDIV.

FIG. 7 is a table of the mean absolute error (%) comparison of 8-bit precision SC division operation with the conventional correlated bit-stream generators.

FIG. 8 is a table of the mean absolute error (%) comparison of 8-bit precision SC division operation with the proposed correlated bit-stream generators.

FIG. 9A provides the image matting performance on alpha estimation using division operation. The proposed bit-stream generator is fed to the CORDIV design. The original alpha- and estimated alpha-related calculations yield blended images to be used as a performance check (I vs. Î). PSNR refers to the peak signal-to-noise ratio. SSIM refers to structural similarity. The maximal length LFSR with the polynomial x⁸+x⁴+x³+x²+1 was used. N=2⁸.

FIG. 9B provides the image matting performance on alpha estimation using division operation. The proposed bit-stream generator is fed to the CORDIV design. In this figure, the performance results of different Sequences are used in the shared RNG method.

FIG. 9C provides the image matting performance on alpha estimation using division operation. The proposed bit-stream generator is fed to the CORDIV design. In this figure, the performance results of different Sequences are used in the proposed generator.

FIG. 10 is a chart of the hardware costs of generating one SC bit-stream for N=2⁸.

FIG. 11 is a chart of the ISO-accuracy hardware cost comparison of generating two LD bit-streams with the shared RNG and the disclosed method.

FIG. 12 is computing code for the method as executed in MATLAB using the stochastic divider using correlated bit streams incorporating the CORDIV design.

FIG. 13 is computing code for the down counter used in the disclosed design as executed in design compiler.

### BACKGROUND OF THE INVENTION

Stochastic Computing (SC) has emerged as an alternative computing paradigm, drawing attention to low-cost and noise-tolerant hardware designs for complex arithmetic operations. In SC, numbers are represented using uniform random bit-streams. Unlike traditional binary computing, which operates on positional inputs, SC processes bit-streams with no significant digit. In this unconventional representation, the ratio of the number of Is to the length of the bit-stream determines the data value. By harnessing the information conveyed by logic-1 and logic-0 and employing unipolar or bipolar encoding, complex arithmetic operations can be implemented through logic circuits.

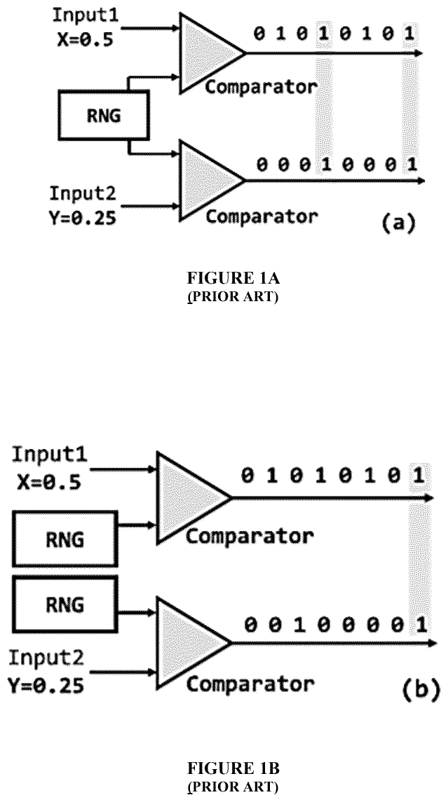

Bit-stream generation is an essential step in SC, which directly affects the accuracy of the computations. To generate stochastic bit-streams, a random number generator (RNG) alongside a binary comparator is utilized. Correlated bit-streams, with high overlap in the position of Is, can be generated by sharing a common RNG between different inputs, as depicted in FIG. 1A. Using a different RNG for each input can produce uncorrelated bit-streams as shown in FIG. 1B. Correlation or independence directly impacts the accuracy and functionality of stochastic circuits. For instance, an AND gate is used as an SC multiplier when independent bit-streams are connected to its inputs. The same gate acts as a minimum operator when there is a high (positive) correlation (i.e., maximal overlap) between input bit-streams.

The initial development of SC-based dividers is attributed to the known Gaines's adaptive digital element (ADDIE) design. An alternative approach involves the use of a simple JK flip-flop. Prior works have explored a low-cost stochastic division architecture known as Correlated Division (CORDIV), which takes advantage of correlation. Previously proposed in the art is a Saturating Subtractor Division (SSDIV) design incorporating a saturating subtractor circuit alongside a JK flip-flop. Another work introduced an alternate stochastic division design that evaluates

$$\frac{min ( X , Y )}{max ( X , Y )}$$

as the output bit-stream where X and Y are stochastic dividend and divisor bit-streams, respectively. This is known as Min-Max-based SC division or MMDIV.

SC has emerged as a promising model of computation, offering remarkable advantages such as resilience to noise, high parallelism, and power efficiency. SC has found applications in various domains, including image processing, sorting, and machine learning, among others. The key strength of SC lies in its ability to perform complex arithmetic operations using simple logic gates, leading to significant cost savings in hardware implementation. A crucial step in SC systems is the conversion of real numbers into bit-streams, wherein each bit position holds equal significance, distinguishing it from conventional binary representation. SC operates on data within the unit interval [0, 1]. For instance, a data value of 0.5 is represented by a bit-stream with 50% of its bits set to 1. This encoding format is known as unipolar encoding (UPE). In UPE, the probability of observing a ‘1’ in the bit-stream X, denoted as P(X=1), equals the input value x. Typically, generating a bit-stream of length N involves comparing N random numbers (R1 . . . . RN) with the input value over N cycles. If the input value is greater than the random number, a logic 1 is produced; otherwise, a logic 0 is produced. The occurrence of logic 1s in the resulting bit-stream depends on the sequence of random numbers. In scenarios involving signed values (x within the range−1<x<1), bipolar encoding (BPE) is employed.

Multiplication of bit-streams in UPE is achieved through bitwise AND operation. To ensure accurate multiplication, the input bit-streams must be uncorrelated. Performing bitwise AND on correlated bit-streams, i.e., bit-streams with the maximum overlap in the positions of Is, yields the input bit-stream with minimum value. Scaled addition in SC is realized using a multiplexer (MUX) unit for both encoding formats. While the main inputs of the MUX can be correlated, they should be uncorrelated with the select input bit-stream.

SC supports a wide range of arithmetic operations, including division. FIG. 3 summarizes the important prior SC division circuits. In addition to more complex designs, simple yet effective division circuits have been investigated in the SC literature. For instance, a JK flip-flop can serve as an approximate divider. By applying the input bit-streams X1 and X2 to the J and K ports of the JK flip-flop, respectively, and setting the probabilities P_{J} and P_{K}, the output bit-stream Y is obtained from the Q port, resulting in a probability P_{Y}=P_{J}/(P_{J}+P_{K}). Although this provides an approximate division, recent efforts have focused on improving the accuracy of the JK flip-flop divider by converging toward P_{Y}=P_{J}/P_{K}. These prior endeavors highlight the ongoing research and development aimed at advancing division circuits in SC. By harnessing the inherent properties of SC, such as correlation, and utilizing various components, such as RNGs, comparators, MUX, and flip-flops, researchers are continuously striving to enhance the accuracy and efficiency of SC division.

### SUMMARY OF THE INVENTION

Disclosed herein is an effective bit-stream generator that can work for all state-of-the-art SC division circuits. Previous designs used two comparators and a shared RNG (see FIG. 1A) to generate correlated bit-streams. In contrast, the disclosed design incorporates a more accurate division operation employing an efficient bit-stream generator comprising a counter, an RNG, and a comparator. The design is validated with an image matting case study. Image matting, based on the problem of separating foreground and background sections in composite images, is a method used to determine the blending ratio of pixel values (alpha values) at the intersection point of two images. This image processing task requires many division operations. Explored are three exemplary topologies in the divider circuits: CORDIV, SSDIV, and MMDIV as state of the art (SOTA) designs that share the common characteristic of being fed with correlated bit-streams.

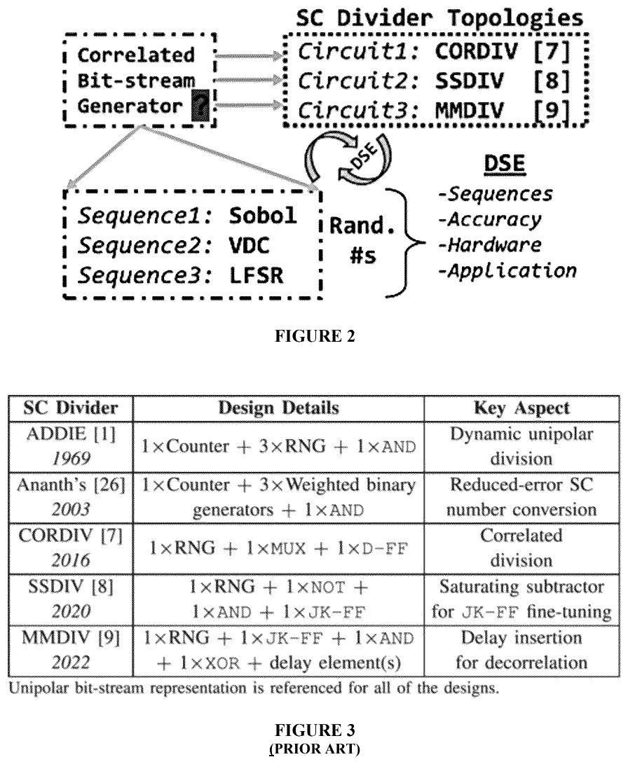

Most prior SC division circuits work with correlated bit-streams, offering both low-cost and highly accurate results. Explored here is the performance of different circuits depicted in FIG. 2. Examined are different types of bit-streams and bit-stream generators from linear-feedback shift registers (LFSRs) to Finite-State Machine (FSM)-based generators. The study employs high-quality random source generators such as Sobol and Van der Corput (VDC) that provide low discrepancy (LD) quasi-orthogonal bit-streams. LD sequences are known in the literature as random sources that achieve high accuracy for SC-based arithmetic. Overall, the disclosed solution achieves a lower arithmetic error of up to 88% improvement when utilizing the simplest Sobol sequence with the SOTA division circuits.

The design provides: (1) an adaptive and versatile bit-stream generator implementable with SC division circuits; (2) a bit-stream generator compatible with different random sequences; and (3) application of the SC Division to the image matting problem, a challenging application that requires extensive division operations in the SC domain.

### DETAILED DESCRIPTION OF THE INVENTION

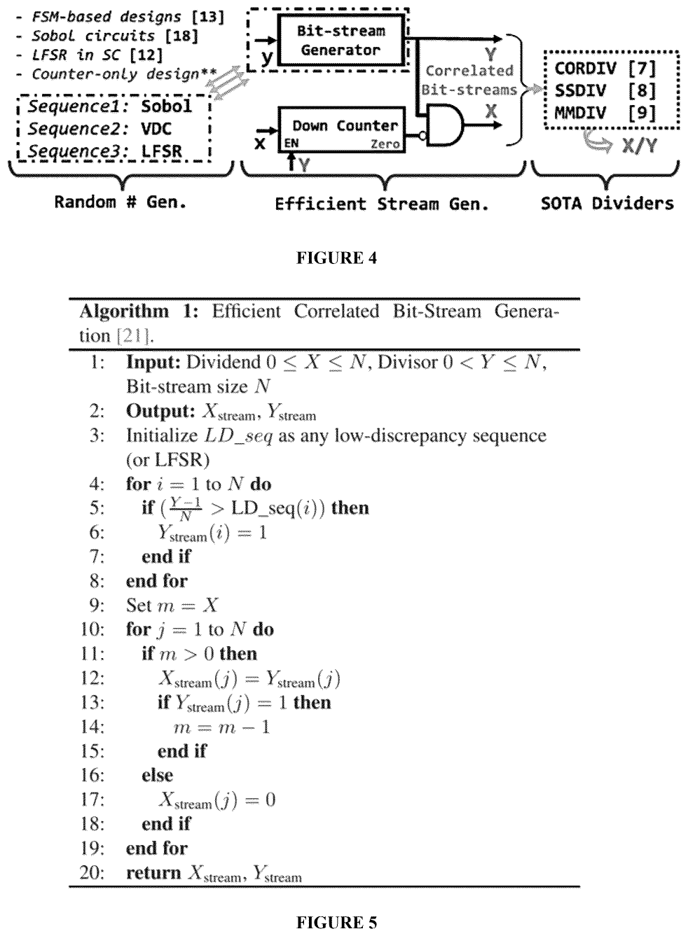

The conventional approach for generating correlated bit-streams (FIG. 1A) uses a shared RNG with two comparators. The disclosed design may include a 1×RNG+1×Comparator (=Bit-stream Generator) for the first and intermediary stream that affects the second stream. The design may be combined with a down counter to generate the second bit-stream with a proper correlation. FIG. 4 illustrates an embodiment of the disclosed design. The first bit-stream generator determines the random number generator for any of the available sequences and correlates the first generated bit-stream through the down counter. As seen in FIG. 4, the disclosed design may comprise a random number generator, a bit-stream generator, a down counter, an AND gate, and one or more dividers. Sequences may be inputted into the bit-stream generator, to generate a bit stream from the sequence inputted. That generated bit stream is AND-ed with the output of the down counter, wherein the value outputted from the down-counter is reversed before the AND operation. The bit-stream generator output and AND gate output, constituting correlated bit streams, are then inputted into the one or more dividers to generate the division solution.

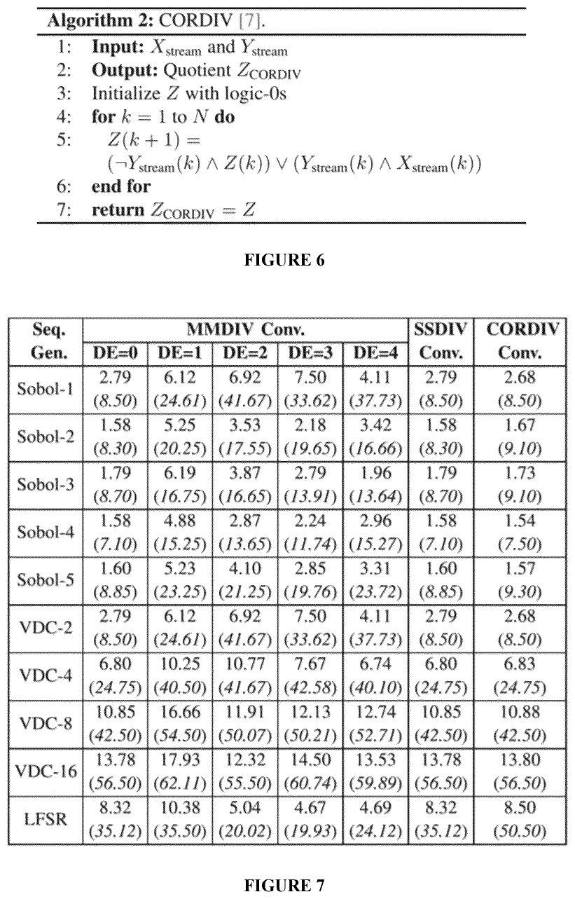

Algorithm 1 shown in FIG. 5 outlines the steps for suitable correlated bit-stream generation. Once the to-be-divided values X and Y are converted into bit-streams, they are used as inputs to the CORDIV design. The Y bit-stream is initially generated by using any LD sequence (or LFSR). Concurrently, the second bit-stream is generated with proper correlation using the down counter. The proposed correlator circuit receives the data in binary format. The Y bit-stream is produced directly by a bit-stream generator, while the X bit-stream duplicates the Y bit-stream. This procedure goes on until the down counter, starting from x, counts down at each clock cycle to reach zero. This activates the zero port that forces the remaining bits to zero. The enable signal of the down counter is controlled by the Y bit-stream. Here, at the cost of a down counter and an AND gate, generated is a bit-stream (divisor) correlated with another bit-stream (dividend). After generating bit-streams with the proposed approach, Algorithm 2 shown in FIG. 6 performs the division operation according to the MUX structure of CORDIV.

Next is a comprehensive accuracy evaluation of the SOTA SC division designs by incorporating two LD sequence generators, Sobol and VDC. We compared the accuracy of these designs with that of the conventional LFSR-based designs. To assess the accuracy of the SC dividers, we utilize the Maximum and Mean Absolute Error (MAE) metrics for all possible 8-bit precision values within the range of [0, 255]. Both the dividend and divisor are assigned 2⁸-bit SC bit-streams. FIG. 7 presents the MAE comparison of the SOTA SC dividers that incorporate shared RNGs for generating correlated bit-streams. The numbers underneath each value (in parentheses) correspond to the maximum error for that specific configuration. We used the first 5 Sobol sequences from MATLAB for the Sobol-based and the maximal length LFSR with polynomial function x⁸+x⁴+x³+x²+1 for the LFSR-based designs.

We observe that using LFSR with the MMDIV design improves the accuracy when the number of DEs increases. However, using Sobol sequences instead of LFSR yields even better accuracy without the need for any DEs. Hence, this approach reduces the hardware cost by eliminating DEs. For the VDC sequence, we considered bases 2, 4, 8, and 16 during sequence generation. Notably, the base-2 VDC is similar to the first Sobol sequence. The accuracy results for all SC division designs were superior when using VDC with bases 2 and 4 compared to the LFSR case.

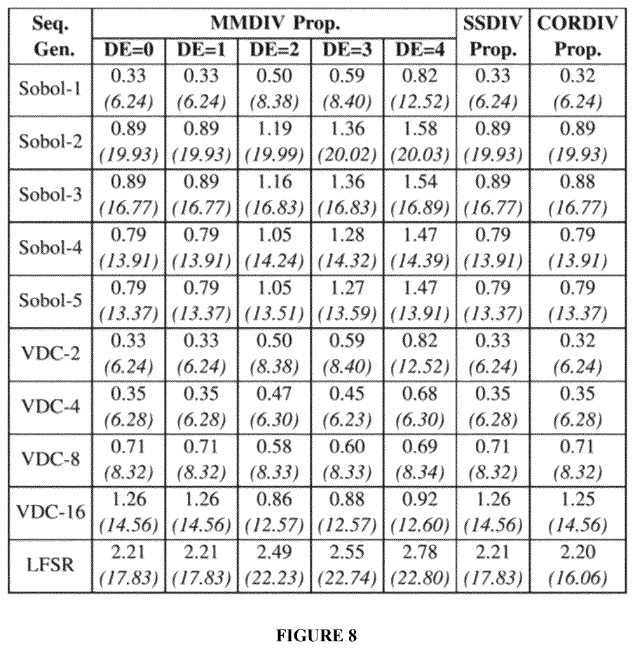

FIG. 8 presents the accuracy results for the proposed method applied to the SOTA SC division designs. We used the same configuration as in FIG. 7. In the LFSR case, increasing the number of DEs in the MMDIV design led to a degradation in accuracy because by adding more DEs, the required independence is diminished due to utilizing the proposed correlated SC bit-streams. This property also affects the hardware footprint of the division circuit. Similarly, for Sobol sequences, the accuracy behavior was consistent. Consequently, there is no need to incorporate DEs in the MMDIV design when using the proposed method. Compared to the results in FIG. 7, the proposed method demonstrated significant improvements in the accuracy of the SC division. As can be seen in FIGS. 7 and 8, the accuracy improvement regarding the errors for the first Sobol sequence is up to 88%. For the LFSR case, the proposed method yielded an accuracy improvement of over two times. As can be seen, compared to the shared RNG method, all the VDC-based designs are superior to the LFSR counterpart with the proposed bit-stream generator. Notably, the proposed method achieves the same level of accuracy for both the CORDIV and SSDIV designs. In addition to SC-based division, the VDC-based bit-stream generator shows better performance compared to other generators in various computing elements, including the SC multiplier and scaled adder.

Next, we evaluate the performance of the proposed approach in an image processing case study. SC gained popularity for the simple execution of complex tasks such as image processing tasks. Presently in the art there is no definitive solution for separating composite images created through image blending. Image blending involves merging foreground and background images to create a composite image. By reversing the process, image matting is a more intricate task that encompasses the extraction of the foreground object from a composite image. Achieving accurate separation requires iterative division operations. Initially, we have three inputs: (a) B (Background) image, (b) F (Foreground) image, and (c) foreground opacity or matte (the foreground image includes this additional information in the form of an extra image channel, alpha: a, which contains green screen background information). While opacity (c) information provides a value of 0 for entirely background regions, it offers precise values within the range [0,1] specifically for the foreground (b) and intersection areas. The image matting is based on alpha estimation that is derived from: I=B×(1−α)+F×α (blending formula), where/as an output represents the merged image. This operation involves multiplication, addition, subtraction-from-1 and can be performed in a single iteration; however, estimating the a value from the merged image, along with the background (a) and foreground (b) information, is a challenging task that requires multiple iterations. The refinement equation can be expressed as

$$\hat{α} = \frac{I - B}{P - B}$$

and is called alpha estimation. Alpha estimation requires the following inputs:/(the merged image using the original alpha), B, and F. The alpha estimation involves a division operation. The result of this operation outputs the estimated transparency \hat{α} particularly affecting the edge pixels of the foreground object, which in turn contributes to the overall natural appearance of the image.

A prior art illustrates the potential number of estimated points within the FB search space using an example image of size 800×600. The estimation process indicates that the number of image pixel couples for estimation can reach up to 108 for the given example. The alpha estimation formula (\hat{α}) is iteratively employed for each operation. Considering the high cost of employing a binary divider in custom hardware, a low-cost and efficient division circuit can help in the accurate implementation of this task. The \hat{α} estimation transforms into an optimization problem for estimating approximate intersection points, which are not precisely known. Generally, a broader border area, including a third region apart from foreground and background, is defined as the intersection region (trimap images), and optimal \hat{α} values are sought for this region. This process requires numerous division operations.

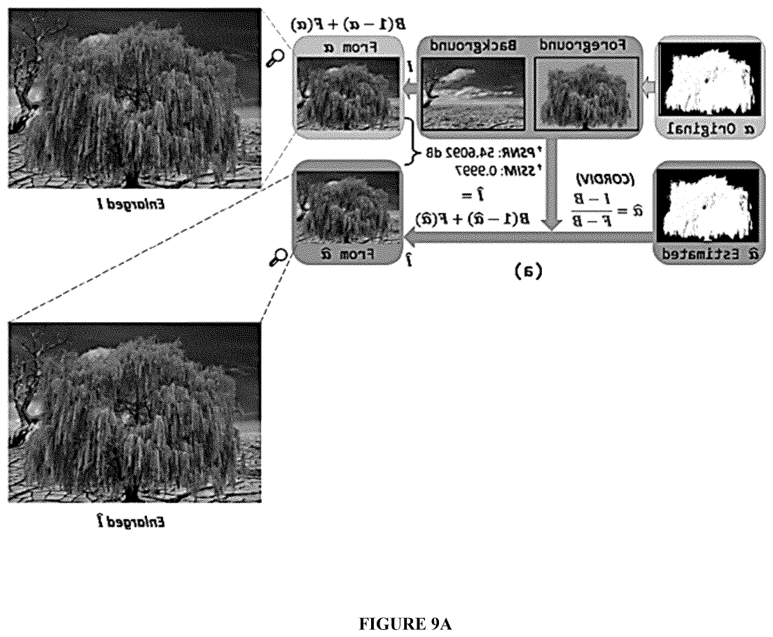

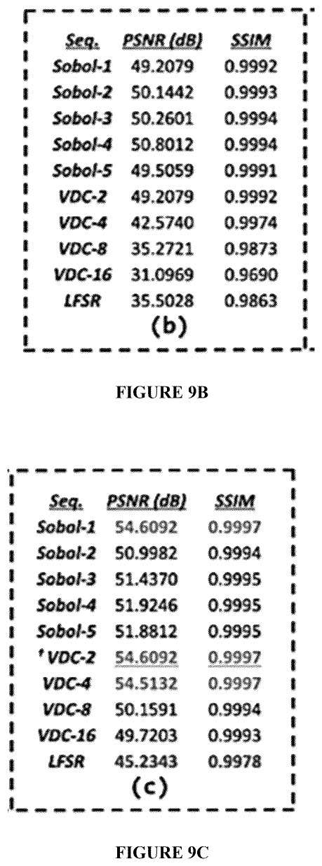

FIG. 9 illustrates the performance results of alpha estimation for X=1−B and Y=F−B using the proposed bit-stream generator and CORDIV circuit

$$( \hat{α} {=}^{⌣} \frac{X}{Y} ) .$$

The example in FIG. 9A demonstrates the alpha estimation. Subsequently, the obtained \hat{α} reblends the plain F and B images similar to the original alpha (α), and the resulting comparison is made between I and Î. FIG. 9B presents the accuracy results of the image matting alpha estimation task with the shared RNG-based design. FIG. 9C shows the performance of the same task with the proposed bit-stream generator.

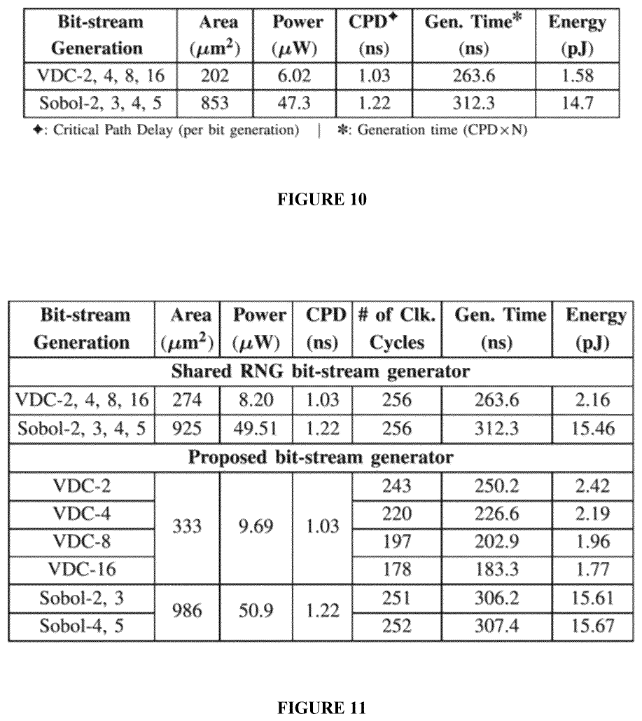

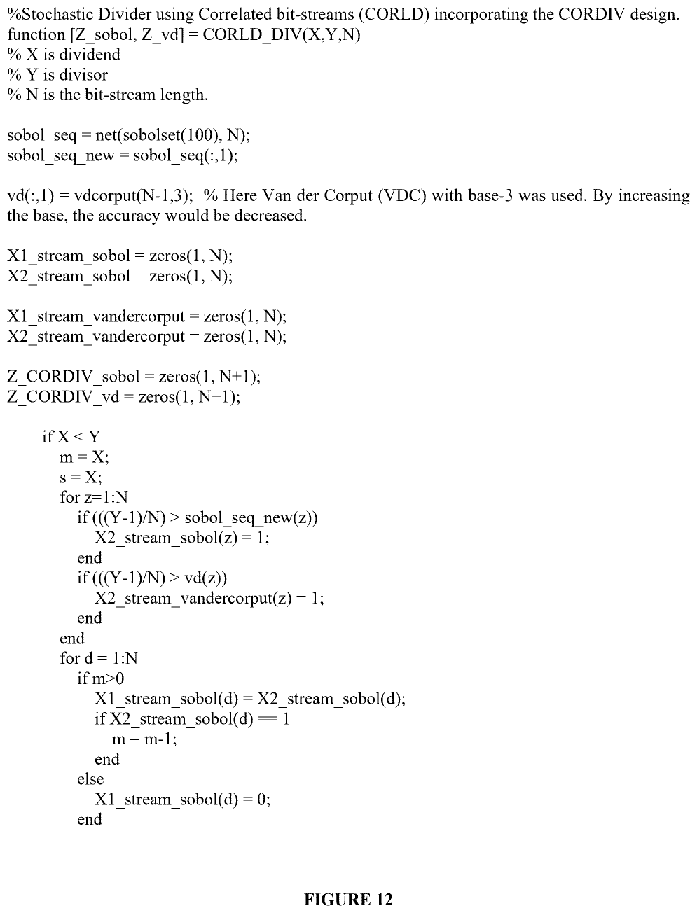

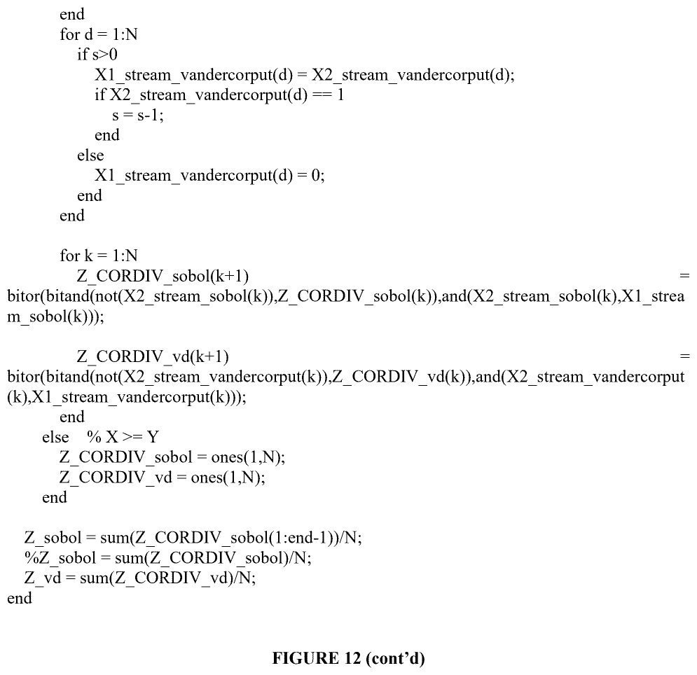

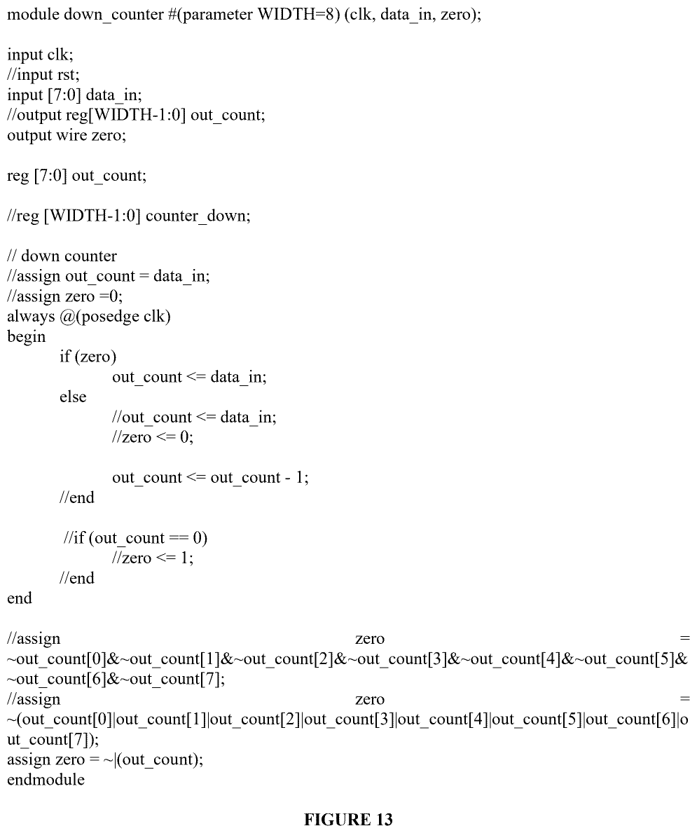

Next conducted is a thorough hardware cost evaluation to assess the cost-efficiency of generating correlated bit-streams using both the shared RNG approach and the proposed method. The designs were synthesized using Synopsys Design Compiler v2018.06 using the 45 nm FreePDK gate library. FIG. 10 compares the hardware costs in terms of hardware footprint, power and energy consumption, and critical path delay (CPD) when generating one SC bit-stream (bit-stream Y in FIG. 4) of length N=2⁸ with Sobol and VDC sequences. The CPD parameter demonstrates the latency for generating one SC bit, while the generation time exhibits the total time to generate the whole SC bit-stream. The total hardware cost when generating the two SC bit-streams with the shared RNG method (FIG. 1A) and the proposed method (FIG. 4) are reported in FIG. 11. The hardware costs with the proposed bit-stream generator are slightly higher than the shared RNG counterpart due to exploiting a down counter, an AND gate, and a NOT gate to generate the second SC bit-stream (bit-stream X in FIG. 4). This minor overhead is negligible compared to the significant enhancement in the accuracy results achieved by utilizing our proposed bit-stream generation method. For an iso-accuracy comparison, we assessed the number of clock cycles (corresponding to the length of bit-streams) to achieve the same accuracy level with the two approaches. FIG. 11 compares energy consumption numbers for both VDC-based and Sobol-based designs. As it can be seen, the VDC-based designs lower the processing time, resulting in lower energy consumption compared to the Sobol-based designs. Finally, we observed that the Sobol-based designs show poor performance when reducing the length of bit-streams, as their accuracy sharply declines when decreasing the length. This was in contrast to the VDC-based bit-streams, which demonstrated greater resilience to reducing the bit-stream length.

The VDC sequence in base-ρ (radix-ρ) can be derived by reversing the integer digits in that base and converting them to a fractional number within the [0,1) interval. Similarly, the first Sobol sequence is constructed by reversing the output bits of a counter. Generating VDC sequences with powers of 2 bases can be accomplished through a straightforward counter implementation, incurring no additional costs. However, for bases other than powers of 2, the hardware design becomes more intricate, leading to higher costs.

By integrating a counter for VDC with bases 2, 4, 8, and 16, the hardware footprint is remarkably small compared to the Sobol cases. In all scenarios, the inclusion of a down counter and an AND gate is necessary to generate the second correlated bit-stream. In terms of hardware efficiency, the VDC design demonstrates an area reduction of 4× and a remarkable energy efficiency improvement of 9× when compared to the Sobol design. Furthermore, the VDC bit-stream generation is 1.18× faster than the Sobol counterpart. Considering the lower accuracy of the LFSR designs, integrating lightweight VDC generators with the proposed bit-stream generator opens up new design possibilities, providing a high accuracy similar to the Sobol sequences.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

While embodiments of the present disclosure have been described using a particular combination of hardware and software, it should be recognized that other combinations of hardware and software are also within the scope of the present disclosure. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMS, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

### REFERENCES

[1] B. R. Gaines, “Stochastic Computing Systems,” in Advances in Information Systems Science. Boston, MA, USA: Springer, 1969, pp. 37-172.
[2] A. Alaghi, W. Qian, and J. P. Hayes, “The promise and challenge of stochastic computing,” IEEE Trans. Comput.-Aided Des. Integr. Circuits Syst., vol. 37, no. 8, pp. 1515-1531 August 2018.
[3] V. T. Lee, A. Alaghi, and L. Ceze, “Correlation manipulating circuits for stochastic computing,” in Proc. Des., Automat. Test Eur. Conf. Exhib., 2018, pp. 1417-1422.
[4] M. H. Najafi, D. J. Lilja, M. D. Riedel, and K. Bazargan, “Low-cost sorting network circuits using unary processing,” IEEE Trans. Very Large Scale Integr., vol. 26, no. 8, pp. 1471-1480 August 2018.
[5] X. Jiao, “An improved stochastic decoding algorithm of LTE turbo codes,” in Proc. Int. Conf.
Wireless Algorithms, Syst., Appl., 2012, pp. 301-308.
[6] S. S. Tehrani, S. Mannor, and W. J. Gross, “Survey of stochastic computation on factor graphs,” in Proc. 37th Int. Symp. Mult.-Valued Log., 2007, pp. 54-54.
[7] T.-H. Chen and J. P. Hayes, “Design of division circuits for stochastic computing,” in Proc. IEEE Comput. Soc. Annu. Symp. VLSI, 2016, pp. 116-121.
[8] S.-I. Chu, “New divider design for stochastic computing,” IEEE Trans. Circuits Syst. II: Exp. Briefs, vol. 67, no. 1, pp. 147-151, January 2020.
[9] S. Wang et al., “Highly accurate division and square root circuits by exploiting signal correlation in stochastic computing,” Int. J. Circuit Theory Appl., vol. 50, pp. 1375-1385, 2022.
[10] J. Wang and M. F. Cohen, “Image and video matting: A survey,” Found Trends Comput. Graph. Vis., vol. 3, pp. 97-175, 2007.
[11] Y. Zhou, G. Xie, J. Han, and Y. Zhang, “Absolute subtraction and di vision circuits using uncorrelated random bitstreams in stochastic computing,” in Proc. IEEE/ACM Int. Symp. Nanoscale Architectures, 2021, pp. 1-6.
[12] J. H. Anderson, Y. Hara-Azumi, and S. Yamashita, “Effect of LFSR seeding, scrambling and feedback polynomial on stochastic computing accuracy,” in Proc. Des., Automat., Test Europe Conf., Exhib., 2016, pp. 1550-1555.
[13] S. Asadi, M. H. Najafi, and M. Imani, “A low-cost FSM-based bit-stream generator for low-discrepancy stochastic computing,” in Proc. Des., Automat., Test Europe Conf., Exhib., 2021, pp. 908-913.
[14] I. M. Sobol, “On the distribution of points in a cube and the approximate evaluation of integrals,” USSR Comp. Math. Math. Phys., vol. 7, no. 4, pp. 86-112, 1967.
[15] J. V. d. Corput, “Verteilungsfunktionen I,” in Proc. Kon. Ned. Akad. v. Wetensch, 1935, pp. 813-821.
[16] M. H. Najafi, D. J. Lilja, and M. Riedel, “Deterministic methods for stochastic computing using low-discrepancy sequences,” in Proc. IEEE/ACM Int. Conf. Comput.-Aided Des., 2018, pp. 1-8.
[17] S. Liu and J. Han, “Energy efficient stochastic computing with sobol sequences,” in Proc. Des., Automat., Test Eur. Conf., Exhibit., 2017, pp. 650-653.
[18] S. Liu and J. Han, “Toward energy-efficient stochastic circuits using parallel sobol sequences,” IEEE Trans. Very Large Scale Integr., vol. 26, no. 7, pp. 1326-1339 July 2018.
[19] M. H. Najafi, D. Jenson, D. J. Lilja, and M. D. Riedel, “Performing stochastic computation deterministically,” IEEE Trans. Very Large Scale Integr., vol. 27, no. 12, pp. 2925-2938 December 2019.
[20] M. S. Moghadam et al., “P2LSG: Powers-of-2 low-discrepancy sequence generator for stochastic computing,” in Proc. Asia South Pacific Des. Automat. Conf., 2024, pp. 1-8.
[21] S. Asadi, M. H. Najafi, and M. Imani, “CORLD: In-stream correlation manipulation for low-discrepancy stochastic computing,” in Proc. IEEE/ACM Int. Conf. Comput. Aided Des., 2021, pp. 1-9.
[22] P. Li, D. J. Lilja, W. Qian, K. Bazargan, and M. D. Riedel, “Computation on stochastic bit streams digital image processing case studies,” IEEE Trans. Very Large Scale Integr., vol. 22, no. 3, pp. 449-462, March 2014.
[23] Z. Li et al., “HEIF: Highly efficient stochastic computing-based inference framework for deep neural networks,” IEEE Trans. Comput.-Aided Des. Integr. Circuits Syst, vol. 38, no. 8, pp. 1543-1556 August 2019.
[24] A. Alaghi and J. P. Hayes, “Exploiting correlation in stochastic circuit design,” in Proc. IEEE 31st Int. Conf. Comput. Des., Asheville, NC, USA, 2013, pp. 39-46.
[25] T. J. Baker and J. P. Hayes, “CeMux: Maximizing the accuracy of stochastic MUX adders and an application to filter design,” ACM Trans. Des. Automat. Electron. Syst., vol. 27, pp. 1-26, 2022.
[26] R. Ananth, “Programmable supervisory circuit and applications thereof,” U.S. Pat. No. 6,618,711, September 2003.
[27] M. Faix et al., “Cognitive computation: An exact Bayesian inference stochastic machine,” Int. J. Softw. Sci. Comput. Intell., vol. 9, no. 3, pp. 37-58, 2017.
[28] M. S. Moghadam et al., “Accurate and energy-efficient stochastic computing with van der Corput sequences,” in Proc. IEEE/ACM Int. Symp. Nanoscale Architectures, 2023, pp. 1-6.
[29] W. Qian, X. Li, M. D. Riedel, K. Bazargan, and D. J. Lilja, “An architecture for fault-tolerant computation with stochastic logic,” IEEE Trans. Comput., vol. 60, no. 1, pp. 93-105, January 2011.
[30] R. Szeliski, Computer Vision Algorithms and Applications. Texts in Computer Science. London, U.K.: Springer, 2011.
[31] A. Levin, D. Lischinski, and Y. Weiss, “A closed-form solution to natural image matting,” IEEE Trans. Pattern Anal. Mach. Intell., vol. 30, no. 2, pp. 228-242, February 2008.
[32] S. Aygun, M. H. Najafi, M. Imani, and E. O. Gunes, “Agile simulation of stochastic computing image processing with contingency tables,” IEEE Trans. Comput.-Aided Des. Integr. Circuits Syst., vol. 42, no. 10, pp. 3474-3478 October 2023.
[33] M. H. Najafi and D. J. Lilja, “High-speed stochastic circuits using synchronous analog pulses,” in Proc. 22nd Asia South Pacific Des. Automat. Conf., 2017, pp. 481-487.
[34] M. Ranjbar, M. E. Salehi, and M. H. Najafi, “Using stochastic architectures for edge detection algorithms,” in Proc. 23rd Iranian Conf. Elect. Eng., 2015, pp. 723-728.
[35] R. Wang, J. Han, B. F. Cockburn, and D. G. Elliott, “Stochastic circuit design and performance evaluation of vector quantization for different error measures,” IEEE Trans. Very Large Scale Integr., vol. 24, no. 10, pp. 3169-3183, 2016.
[36] S. Aygün, M. Altun, and E. O. Güne s, “Sobel filter operation in image processing via stochastic arithmetic-logic unit design,” in Proc. 25th Signal Process. Commun. Appl. Conf., 2017, pp. 1-4.
[37] N. Onizawa, D. Katagiri, K. Matsumiya, W. J. Gross, and T. Hanyu, “Gabor filter based on stochastic computation,” IEEE Signal Process. Lett., vol. 22, no. 9, pp. 1224-1228 September 2015.
[38] N. Onizawa, D. Katagiri, K. Matsumiya, W. J. Gross, and T. Hanyu, “An accuracy/energy-flexible configurable Gabor-filter chip based on stochastic computation with dynamic voltage-frequency-length scaling,” IEEE J. Emerg. Sel. Topics Circuits Syst., vol. 8, no. 3, pp. 444-453, September 2018.
[39] K. Boga, N. Onizawa, F. Leduc-Primeau, K. Matsumiya, T. Hanyu, and W. J. Gross, “Stochastic implementation of the disparity energy model for depth perception,” in Proc. IEEE Workshop Signal Process. Syst., 2015, pp. 1-6.
[40] H. Abdellatef et al., “Accurate and compact stochastic computations by exploiting correlation,” Turkish J. Elect. Eng. Comput. Sci., vol. 27, pp. 547-564, 2019.
[41] S. Dai, M. Han, W. Xu, Y. Wu, and Y. Gong, “Soft edge smoothness prior for alpha channel super resolution,” in Proc. IEEE Conf. Comput. Vis. Pattern Recognit., 2007, pp. 1-8.
[42] J. Wang and M. F. Cohen, “Optimized color sampling for robust matting,” in Proc. IEEE Conf. Comput. Vis. Pattern Recognit., 2007, pp. 1-8.
[43] K. He, C. Rhemann, C. Rother, X. Tang, and J. Sun, “A global sampling method for alpha matting,” in Proc. IEEE/CVF Conf. Comput. Vis. Pattern Recognit., 2011, pp. 2049-2056.
[44] D. Cho, S. Kim, Y.-W. Tai, and I. S. Kweon, “Automatic trimap generation and consistent matting for light-field images,” IEEE Trans. Pattern Anal. Mach. Intell., vol. 39, no. 8, pp. 1504-1517 August 2017.

We claim:

1. A circuit device for performing division operations in a stochastic computing device comprising:
at least two inputs;
at least one bit-stream generator, comprising:
a random number generator; and
a comparator;
a down counter;
an AND gate;
a divider; and
electronic circuitry connecting the circuit components;
wherein the bit-stream generator determines the random number generator for one input;
wherein one other input correlates the first generated bit stream through the down counter;
wherein one input is an input for the bit-stream generator;
wherein other input is an input for the down counter;
wherein an output of the bit-stream generator and an output of the down counter are inputs for the AND gate;
wherein the output of bit-stream generator comprises a divisor;
wherein the output of the AND gate comprises a dividend; and
wherein the divisor and the dividend are inputs for the divider.

2. The device of claim 1 wherein the divider comprises functionality to perform correlated division.

3. The device of claim 1 wherein the divider comprises functionality to perform saturating subtractor division.

4. The device of claim 1 wherein the divider comprises functionality to perform min-max-based stochastic division.

5. A method for performing division operations in a stochastic computing device comprising:
a. providing a circuit device comprising:
at least two inputs, comprising X and Y;
at least one bit-stream generator, comprising:
a random number generator; and
a comparator;
a down counter;
an AND gate;
a divider; and
electronic circuitry connecting the circuit components;
b. inputting one input to one bit stream generator;
c. initializing a low discrepancy sequence by one bit stream generator to create a Y bit-stream;
d. creating a correlated bit-stream, comprising an X bit-stream, by one bit stream generator, the down counter, and the AND gate;
e. inputting the Y bit-stream and X bit-stream to the divider;
f. dividing the X bit-stream by the Y bit-stream by the divider; and
g. outputting a result.

6. The method of claim 5 wherein data received from the at least two inputs is in binary format.

7. The method of claim 5 wherein the division step performed by the divider comprises correlated division.

8. The method of claim 5 wherein the division step performed by the divider comprises saturating subtractor division.

9. The method of claim 5 wherein the division step performed by the divider comprises min-max-based stochastic division.

10. The method of claim 5, wherein the step to create the correlated bit-stream comprises:
a. the down counter counts each clock cycle;
b. one bit stream generator duplicates the Y-bit stream for each bit, comprising if
$$\frac{Y - 1}{N} > LD\_seq ( i ) ,$$
then the bit equals 1;
wherein N represents a bit-stream size;
and i represents a placement of a bit within a bit-stream, such that i=1 to N;
c. repeating steps a and b above until the clock cycle equals zero; and
d. setting all remaining bits to zero by a zero port.
